(19) United States
(12) Patent Application Publication
(10) Pub. No.: US 2018/0241937 A1
(43) Pub. Date: Aug. 23, 2018

(54) DIRECTED CONTENT CAPTURE AND CONTENT ANALYSIS

(71) Applicant: Microsoft Technology Licensing, LLC, Redmond, WA (US)

(72) Inventors: Mark Davis Schwesinger, Bellevue, WA (US); Michal Hlavac, Seattle, WA (US); Mark A. DeFalco, Bellevue, WA (US); John Alexander McElmurray, Seattle, WA (US)

(73) Assignee: Microsoft Technology Licensing, LLC, Redmond, WA (US)

(21) Appl. No.: 15/436,330

(22) Filed: Feb. 17, 2017

(51) Int. Cl. H04N 5/232; G06K 9/62; G06T 7/70; G06T 7/60

(52) U.S. Cl. CPC H04N 5/23222; H04N 5/23293; G06T 2207/30244; G06T 7/70; G06T 7/60; G06K 9/6267

(57) ABSTRACT

Aspects of systems and methods for providing directed content capture and content analysis are discussed herein. The directed content capture and content analysis system is configured to receive an indication of an event from the user. The directed content capture and content analysis system provides a user interface detailing desirable content captures needed to thoroughly document the event. Further, the directed content capture and content analysis system is configured to analyze the captured content to provide assistance to the user. Specifically, by understanding the captured content, the directed content capture and content analysis system may passively or proactively help the user capture the best set of content for the moments in the user's life.

### BACKGROUND

People typically desire to document various events throughout their life including celebrations, parties, and trips. While most people aspire to completely document the event, unfortunately, most people experience difficulty with capturing a full story of the event. In one common scenario, a person attends an event and quickly becomes occupied with experiencing the event. After the event has concluded, the person realizes that they did not document any of the event. Alternatively, the person may sporadically document various portions of the event, which provides glimpses of the various portions of the event. However, most people are not professional photographers and, as a result, are unfamiliar with which shots may be desirable or undesirable. As a result, the sporadic documentation often provides an incomplete story of the event, which may result in missing key moments, capturing non-ideal shots, capturing shots from incorrect angles, or only capturing a subset of the attendees.

### SUMMARY

This summary is provided to introduce a selection of concepts in a simplified form that are further described below in the Detailed Description section. This summary is not intended to identify all key or essential features of the claimed subject matter, nor is it intended as an aid in determining the scope of the claimed subject matter.

Aspects of systems and methods for providing directed content capture and content analysis are discussed herein. The directed content capture and content analysis system provides the user with a directed content capture experience for various events. The directed content capture and content analysis system is configured to receive an indication of an event from the user. Based on the event type, the directed content capture and content analysis system provides a user interface detailing desirable content captures needed to thoroughly document the event. Further, the directed content capture and content analysis system is configured to analyze the captured content to provide assistance to the user. Specifically, by understanding the captured content, the directed content capture and content analysis system may passively or proactively help the user capture the best set of content for the moments in the user's life. In one example, the directed content capture and content analysis system is configured to analyze the captured content to ensure that the captured content meets the depiction of the desirable content captures, which may include verifying that key moments associated with the event are captured, the angle of view of the captured content is appropriate, and that all of the event attendees are captured. In another example, the directed content capture and content analysis system is configured to proactively notify the user of desirable content that has not been captured. Further, in yet another example, the directed content capture and content analysis system is configured to depict an ideal content capture to the user.

Accordingly, the directed content capture and content analysis system optimizes the content capture experience to thoroughly document an event. Through analysis of the captured content, the directed content capture and content analysis system is configured to determine whether the captured content reflects the desirable content captures. Further, the directed content capture and content analysis system optimizes the computing device to provide a directed content capture experience with the desirable content captures, such as a content capture preview depicting the correct angle of view. By optimizing the content capture experience, the system conserves computing resources and network bandwidth by providing the user with a directed content capture experience that reduces the need to capture voluminous content.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram of a representation of an example operating environment implementing directed content capture and content analysis;

FIG. 2 is an illustration of an example computing device displaying a graphical user interface of an application providing directed content capture and content analysis;

FIG. 3 is an illustration of an example computing device displaying a graphical user interface of an application providing directed content capture and content analysis;

FIG. 4 is an illustration of an example computing device displaying a graphical user interface of an application providing directed content capture and content analysis;

FIG. 5 is an illustration of an example computing device displaying a graphical user interface of an application providing directed content capture and content analysis;

FIG. 6 is an illustration of an example computing device displaying a graphical user interface of an application providing directed content capture and content analysis;

FIG. 7 is an illustration of an example computing device displaying a graphical user interface of an application providing directed content capture and content analysis;

FIG. 8 is an illustration of an example computing device displaying a graphical user interface of an application providing directed content capture and content analysis;

FIG. 9 is an illustration of an example computing device displaying a graphical user interface of an application providing directed content capture and content analysis;

FIG. 10 is an illustration of an example computing device displaying a graphical user interface of an application providing directed content capture and content analysis;

FIG. 11 is an illustration of an example computing device displaying a graphical user interface of an application providing directed content capture and content analysis;

FIG. 12 is a flow chart showing general stages involved in an example method for providing directed content capture and content analysis;

FIG. 13 is a block diagram illustrating example physical components of a computing device;

FIGS. 14A and 14B are block diagrams of a mobile computing device; and

FIG. 15 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Aspects of systems and methods for providing directed content capture and content analysis are discussed herein. The directed content capture and content analysis system provides the user with a directed content capture experience for various events. The directed content capture and content analysis system is configured to receive an indication of an event from the user. Based on the event type, the directed content capture and content analysis system provides a user interface detailing desirable content captures needed to thoroughly document the event. Further, the directed content capture and content analysis system is configured to analyze the captured content to provide assistance to the user. Specifically, by understanding the captured content, the directed content capture and content analysis system may passively or proactively help the user capture the best set of content for the moments in the user's life. In one example, the directed content capture and content analysis system is configured to analyze the captured content to ensure that the captured content meets the depiction of the desirable content captures, which may include verifying that key moments associated with the event are captured, the angle of view of the captured content is appropriate, and that all of the event attendees are captured. In another example, the directed content capture and content analysis system is configured to proactively notify the user of desirable content that has not been captured. Further, in yet another example, the directed content capture and content analysis system is configured to depict an ideal content capture to the user.

Accordingly, the directed content capture and content analysis system optimizes the content capture experience to thoroughly document an event. Through analysis of the captured content, the directed content capture and content analysis system is configured to determine whether the captured content reflects the desirable content captures. Further, the directed content capture and content analysis system optimizes the computing device to provide a directed content capture experience with the desirable content captures, such as a content capture preview depicting the correct angle of view. By optimizing the content capture experience, the system conserves computing resources and network bandwidth by providing the user with a directed content capture experience that reduces the need to capture voluminous content.

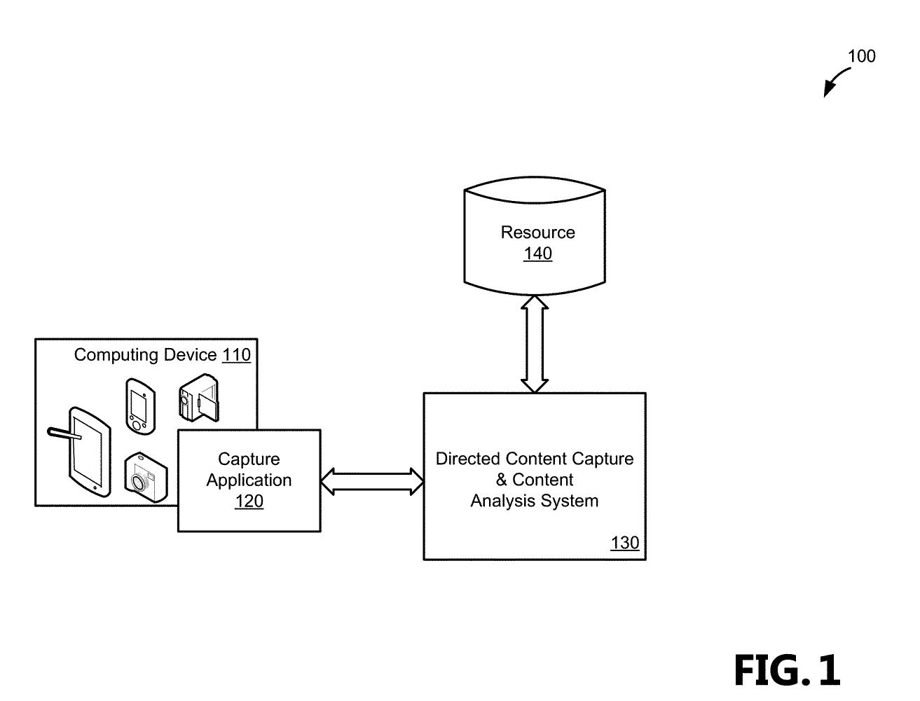

FIG. 1 is a block diagram of a representation of an example environment 100 implementing directed content capture and content analysis. The example environment 100, as illustrated, includes a computing device 110 running a capture application 120 configured to capture content. Further, the capture application 120 communicates with the directed content capture and content analysis system 130, which is in communication with one or more resources 140.

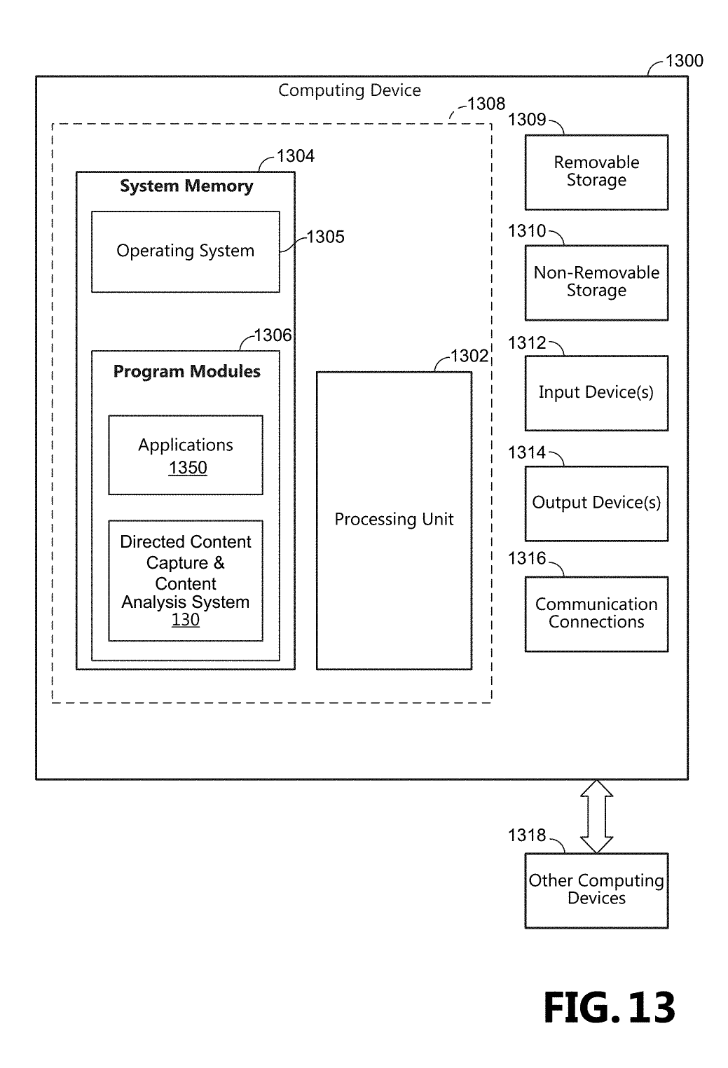

The computing device 110 is illustrative of a variety of computing systems including, without limitation, a laptop computer, wireless computing devices, mobile computing devices (e.g., mobile telephones, netbooks, tablet or slate type computers, notebook computers, and laptop computers), image capture devices, wearable devices, gaming devices, hand-held devices, microprocessor-based or programmable consumer electronics, and minicomputers. The hardware of these computing systems is discussed in greater detail in regard to FIGS. 13, 14A, 14B, and 15. In various aspects, the computing device 110 is accessible locally and/or by a network, which may include the Internet, a Local Area Network (LAN), a private distributed network for an entity (e.g., a company, a university, a government agency), a wireless ad hoc network, a Virtual Private Network (VPN) or other direct data link (e.g., Bluetooth connection, a direct wired link).

Further, the computing device 110 in the example environment 100 utilizes a capture application 120 executing on the first computing device 110. The capture application 120 provides a user interface displaying the directed capture experience. According to various aspects, the capture application 120 includes functionality for capturing content items locally by the computing device, collaboratively across multiple computing devices, or online via a server as a remote application. According to other aspects, the capture application 120 may utilize another application on the computing device 110 that provides functionality for capturing content.

The directed content capture and content analysis system 130 provides the user with a directed content capture experience for various events. More specifically, the directed content capture and content analysis system 130 is configured to receive an indication of an event from the user. Based on the event type, the directed content capture and content analysis system 130 provides a user interface detailing desirable content captures needed to thoroughly document the event. In various aspects, the computing device 110 the directed content capture and content analysis system 130 may be implemented in one device or implemented in separate devices in communication with one another. Various servers and intermediaries may lie between the computing device 110 and the directed content capture and content analysis system 130. The directed content capture and content analysis system 130 may be in the form of a cloud-based service provided by a server, a network server, an enterprise system, a desktop computer, a laptop computer, a tablet computer, a handheld computing device, a mobile communication device, and the like.

Further, the directed content capture and content analysis system 130 is configured to provide content analysis of the captured content. According to one aspect, the directed content capture and content analysis system 130 is configured to interact with various resources 140 to provide the analysis functionality. In one example, the directed content capture and content analysis system 130 is in communication with functionality for obtaining the location of the computing device 110. The location information may be utilized by the directed content capture and content analysis system 130 to determine when the user is in position for a particular content capture. Further, the directed content capture and content analysis system 130 analyzes the captured content to provide assistance with the directed capture experience. In one example, the directed content capture and content analysis system 130 is configured to analyze the captured content to ensure that the captured content meets the depiction of the desirable content captures, which may include verifying that key moments associated with the event are captured, the angle of view of the captured content is appropriate, and that all of the event attendees are captured. In another example, the directed content capture and content analysis system 130 is configured to proactively notify the user of desirable content that has not been captured. Further, in yet another example, the directed content capture and content analysis system 130 is configured to depict an ideal content capture to the user.

According to various aspects, the directed content capture and content analysis system 130 is in communication with resources 140, such as a predictive model, to provide this functionality. It should be recognized that the resources 140 may include other forms of artificial intelligence or machine learning. The model trainer is configured to train a plurality of development models via one or more machine learning techniques via the training subset of the data. Machine learning techniques train models to accurately make predictions on data fed into the models (e.g., aspects relating to directed content capture, desirable content captures, content analysis, location information, image recognition). During a learning phase, the models are developed against a training dataset of known inputs (e.g., sample A, sample B, sample C) to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs, in which the training dataset is repeatedly fed into the model to refine its results. For example, in a supervised learning phase, a model is developed to predict the output for a given set of inputs, and is evaluated over several epochs to more reliably provide the output that is specified as corresponding the given input for the greatest number of inputs for the training dataset. In another example, for an unsupervised learning phase, a model is developed to cluster the dataset into n groups, and is evaluated over several epochs in how consistently it places a given input into a given group and how reliably it produces the n desired clusters across each epoch.

Once an epoch is run, the models are evaluated and the values of their variables are adjusted to attempt to better refine the model. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, etc.

The model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. Models that are finalized are evaluated against testing criteria. In a first example, a testing dataset that includes known outputs for its inputs is fed into the finalized models to determine an accuracy of the model in handling data that is has not been trained on. In a second example, a false positive rate, false negative rate may be used to evaluate the models after finalization. In a third example, a delineation between clusterings is used to select a model that produces the clearest bounds for its clusters of data.

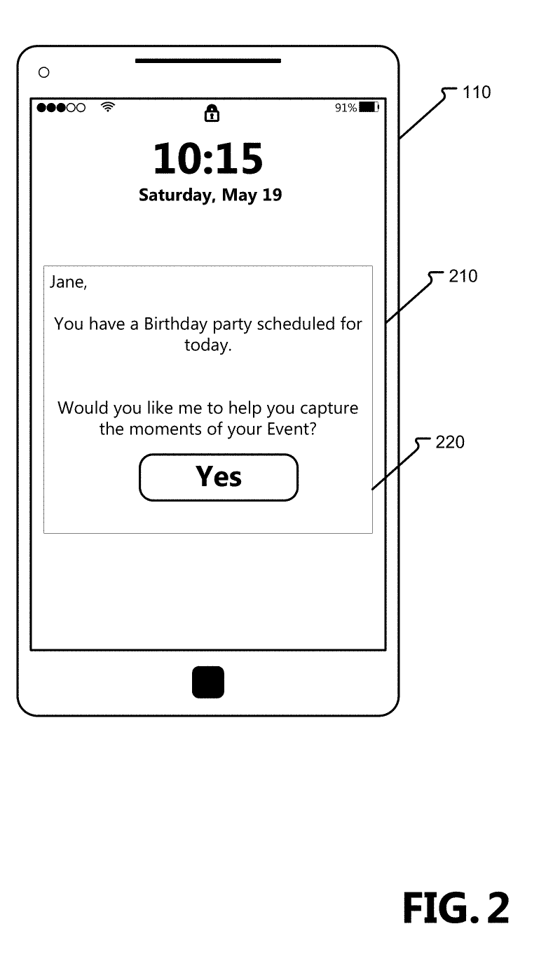

FIG. 2 illustrates an example computing device 110 displaying a graphical user interface 210 of an application providing directed content capture and content analysis. According to one aspect, the directed content capture and content analysis system 130 is configured to proactively provide notifications to the user. In one example, the user interface 210 provides the user with a notification 220 of an upcoming event. In the illustrated example, the user interface 210 provides the user with a notification 220 that the user has a birthday party scheduled for today. Further, the notification 220 includes a prompt requesting whether the user would like assistance capturing the event.

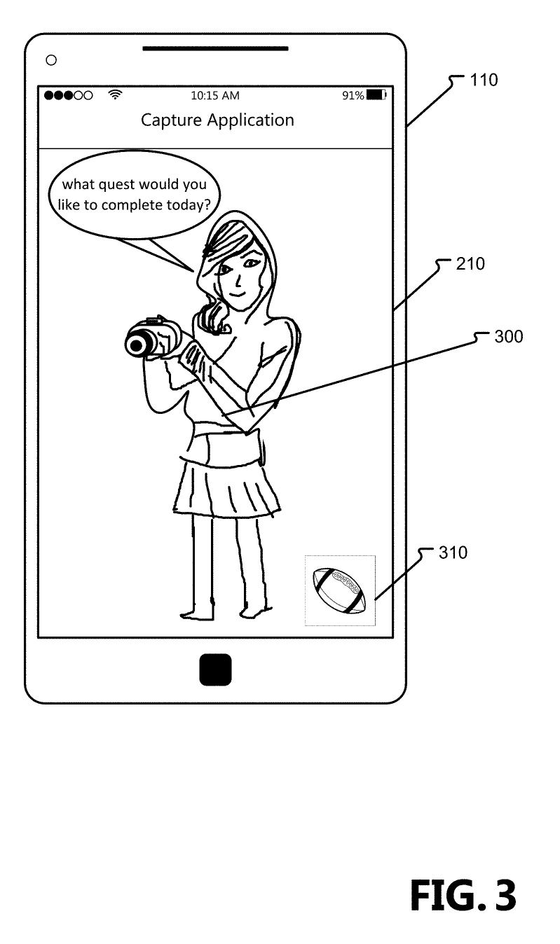

FIG. 3 illustrates an example computing device 110 displaying a graphical user interface 210 of an application providing directed content capture and content analysis. According to one aspect, the directed content capture and content analysis system 130 is configured to provide an interactive application, which may be utilized by the user. As illustrated, the example user interface 210 illustrates details regarding the user. In another example, the user interface 210 illustrates details regarding completed directed captures. In the example illustrated in FIG. 3, the user interface 210 displays a user avatar 300 that includes various directed capture objects 310 that signify that the user has completed a particular directed capture experience.

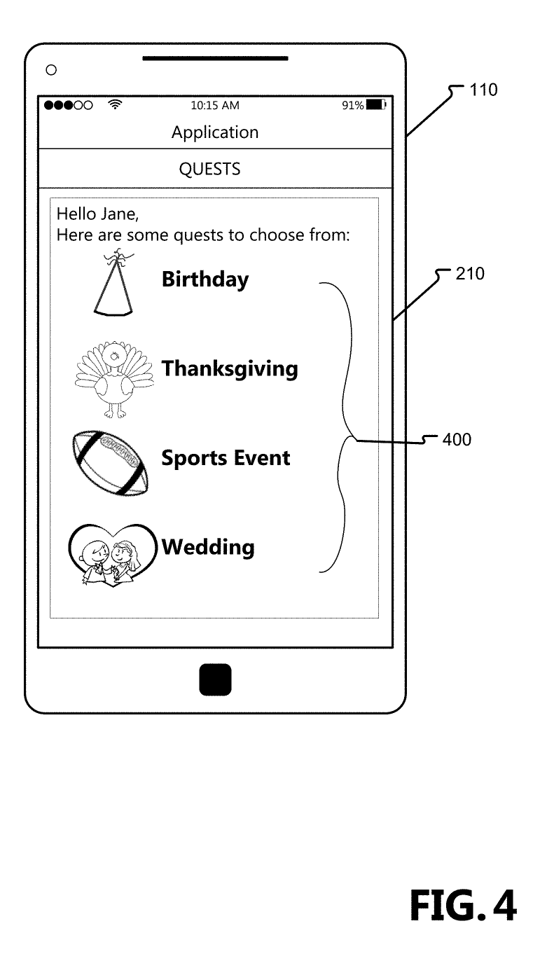

FIG. 4 illustrates an example computing device 110 displaying a graphical user interface 210 of an application providing directed content capture and content analysis. According to one aspect, the directed content capture and content analysis system 130 is configured to provide a user interface 210 for various directed capture experiences. As illustrated, the example user interface 210 displays directed capture experiences 400 for a birthday, Thanksgiving, sports event, and a wedding. As discussed with reference to FIG. 3, once the user has completed one of the directed capture experiences 400, the user's avatar 300 may be updated to include the new directed capture object 310.

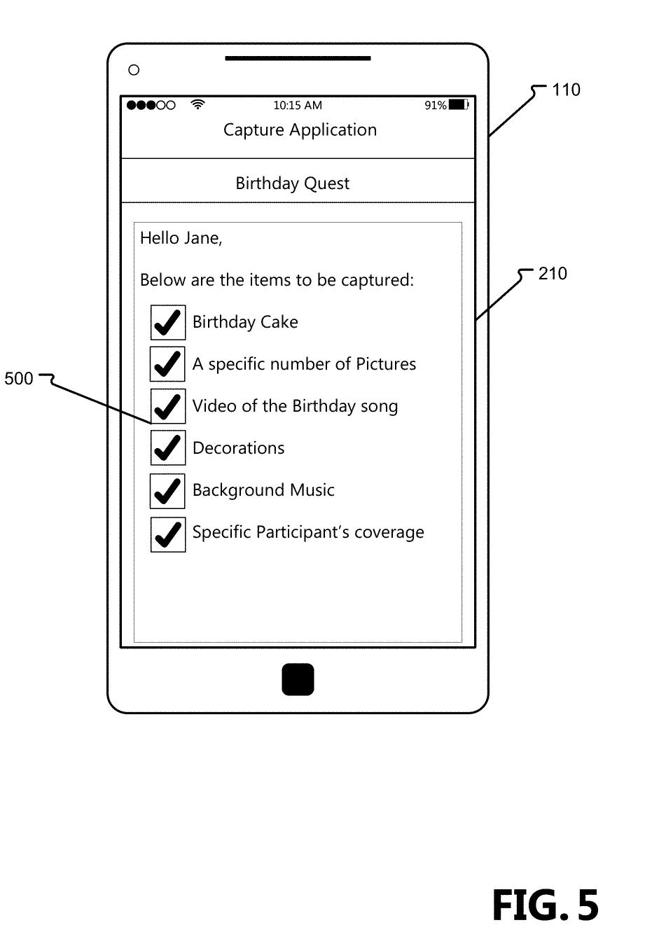

FIG. 5 illustrates an example computing device 110 displaying a graphical user interface 210 of an application providing directed content capture and content analysis. According to one aspect, the directed content capture and content analysis system 130 is configured to provide a user interface 210 displaying a list of content items 500 to be captured during the directed capture experience. The list of content items 500 may include various key moments associated with the event and an additional number of items that permit the user to obtain additional captured content. In the illustrated example, the directed captured experience itemizes various items to be captured for a birthday experience including captured content for a birthday cake, a number of pictures, a video of the birthday song, decorations, background music, and specific persons at the event.

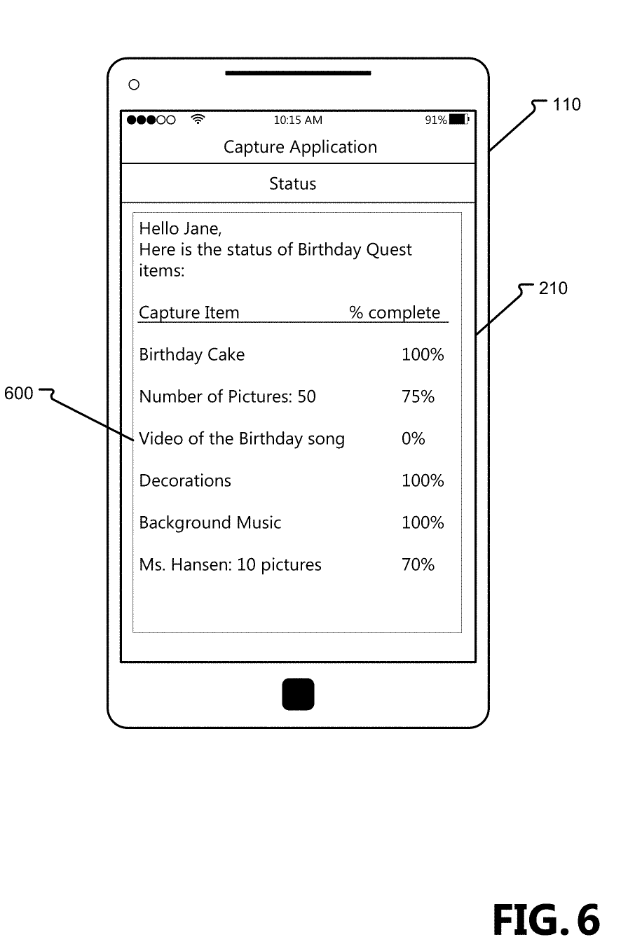

FIG. 6 illustrates an example computing device 110 displaying a graphical user interface 210 of an application providing directed content capture and content analysis. According to one aspect, the directed content capture and content analysis system 130 is configured to analyze the captured content and determine whether the captured content satisfies any content items in the list of content items to be captured during the directed capture experience. Based on the determination, the user interface 210 is configured to display the completion status 600 of a list of content items to be captured during the directed capture experience. As illustrated, the user interface 210 displays that the user has captured the birthday cake, 50 pictures of the event, decorations, background music, and 10 pictures of Ms. Hansen. Based on the displayed status 600, the user is able to determine what type of additional content the user needs to capture.

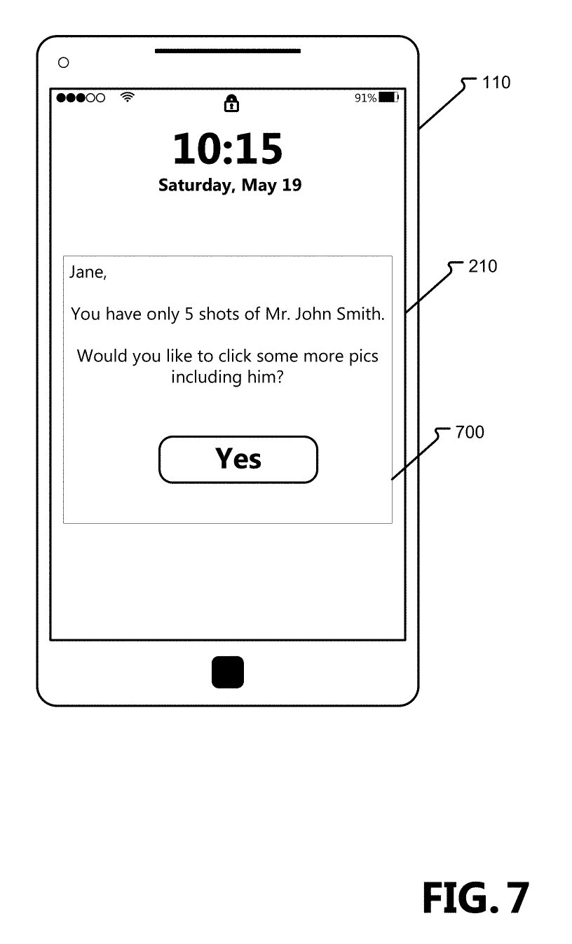

FIG. 7 illustrates an example computing device 110 displaying a graphical user interface 210 of an application providing directed content capture and content analysis. According to one aspect, the directed content capture and content analysis system 130 is configured to analyze the captured content and provide a notification 700 to the user that identifies that additional types of captured content may be needed to fully document the event. In the illustrated example, the user interface 210 displays a notification 700 that notifies the user that only five photos of Mr. John Smith have been taken during the event and prompting the user to capture more.

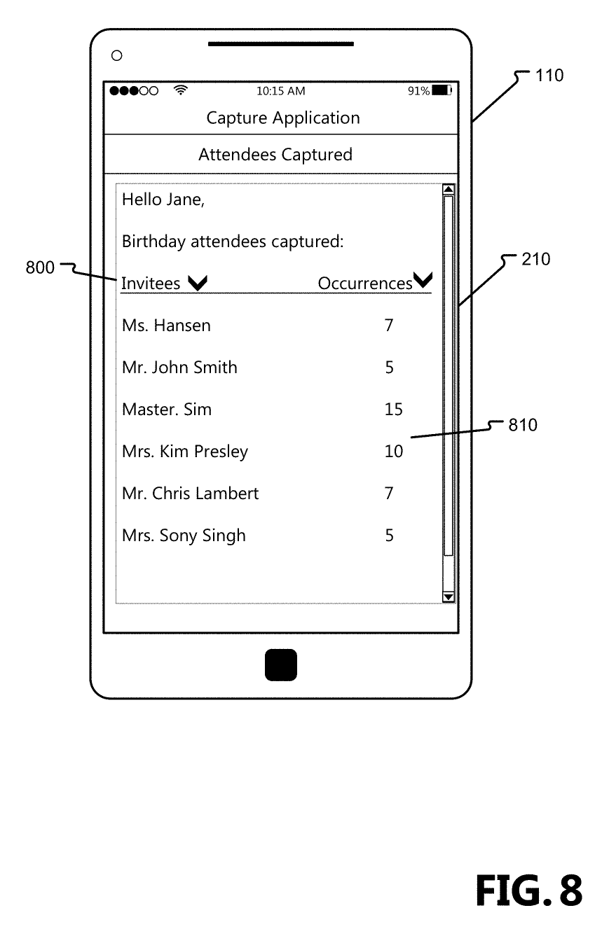

FIG. 8 illustrates an example computing device 110 displaying a graphical user interface 210 of an application providing directed content capture and content analysis. According to one aspect, the directed content capture and content analysis system 130 is configured to query various resources 140 for information regarding the event. According to one example, the directed content capture and content analysis system 130 queries a calendaring application associated with the event invitation. Based on the event invitation, the directed content capture and content analysis system 130 is enabled to determine event attendees, location, event subject, and other contextual information regarding the event. Further, the directed content capture and content analysis system 130 is configured to utilize machine learning to identify event attendees within the captured content such that the directed content capture and content analysis system 130 is able to provide an approximation of captured content of the event attendees. In the illustrated example, the directed content capture and content analysis system 130 displays a user interface 210 providing a list of event attendees 800 and the number of times 810 the event attendees were displayed in captured content.

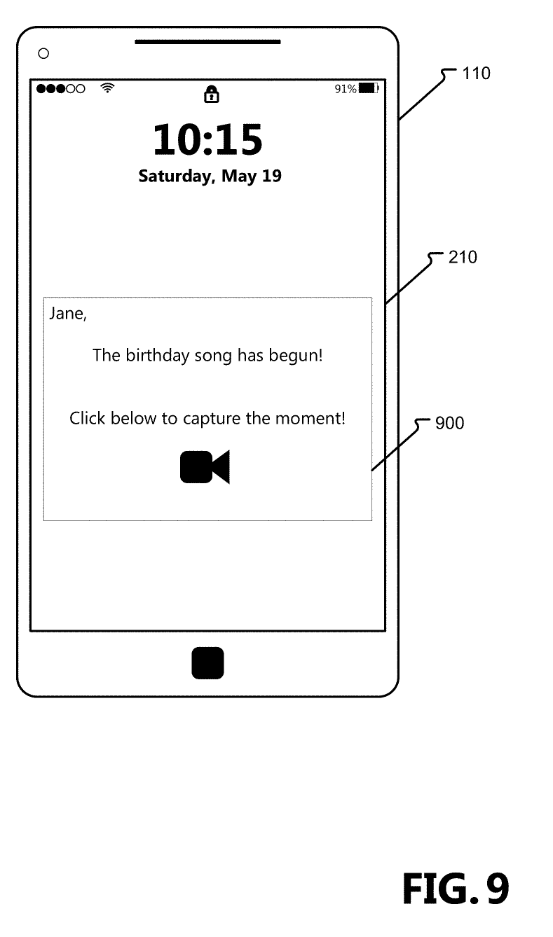

FIG. 9 illustrates an example computing device 110 displaying a graphical user interface 210 of an application providing directed content capture and content analysis. According to one aspect, the directed content capture and content analysis system 130 is configured to monitor various environmental and/or contextual details associated with the event. In one example, the directed content capture and content analysis system 130 may utilize location information for the computing device 110 to determine when the user is in position for a particular content capture. In another example, the directed content capture and content analysis system 130 may utilize audio information at the event to determine when to various moments in the event are occurring, such as a countdown on New Year's Eve, a birthday song, or a wedding processional. Based on the environmental and/or contextual details, the directed content capture and content analysis system 130 is operable to identify when a key moment in the event is occurring or when the user is in an advantageous position for a content capture. In the illustrated example, the directed content capture and content analysis system 130 provides a notification 900 that the birthday song has been recognized and to prompt the user to capture the moment.

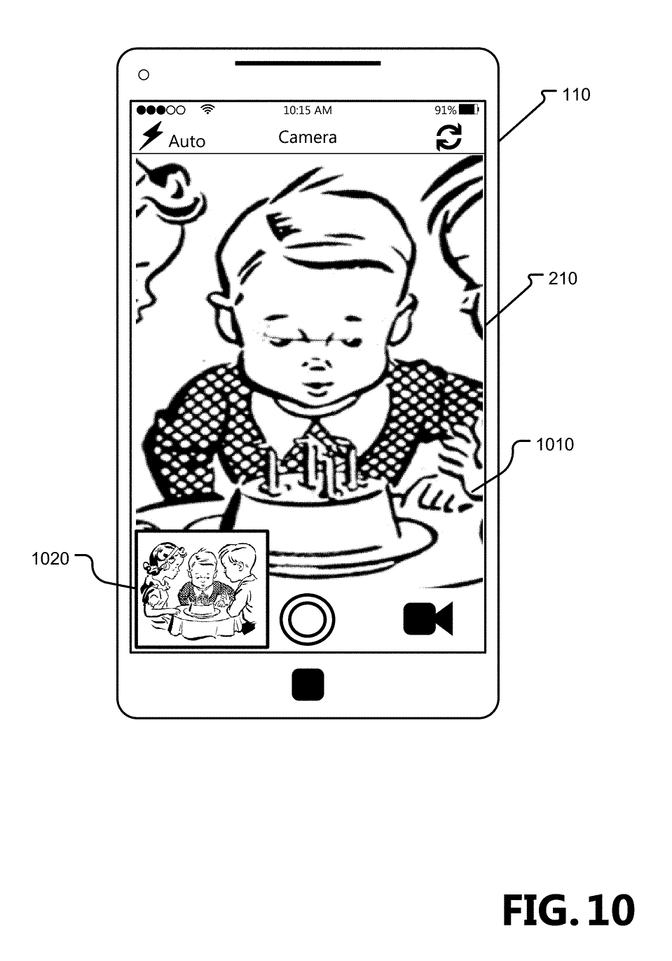

FIG. 10 illustrates an example computing device 110 displaying a graphical user interface 210 of an application providing directed content capture and content analysis. According to one aspect, the directed content capture and content analysis system 130 provides a user interface 210 that guides and/or enhances the content capture. In the illustrated example, the user interface 210 displays a current image 1010 of the user's current focus of the content capture. Further, the user interface 210 displays an ideal image 1020 of a desirable content capture. Accordingly, the user is able to observe from the user interface 210 that the more desirable content capture may use a different angle than the user's current focus, which allows the user to reposition, zoom in or zoom out in order to imitate the more desirable content capture.

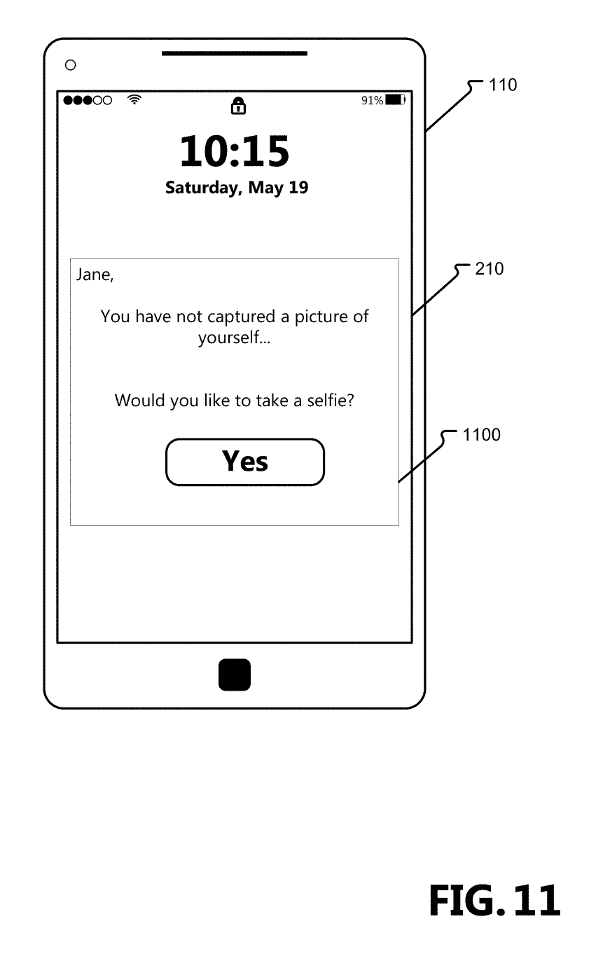

FIG. 11 illustrates an example computing device 110 displaying a graphical user interface 210 of an application providing directed content capture and content analysis. According to one aspect, the directed content capture and content analysis system 130 is configured to analyze the captured content and provide a notification 1100 to the user that additional captured content may be needed to fully document the event. In the illustrated example, the user interface 210 displays a notification 1100 that notifies the user that the user has not been detected in the captured content and prompting the user to capture a selfie.

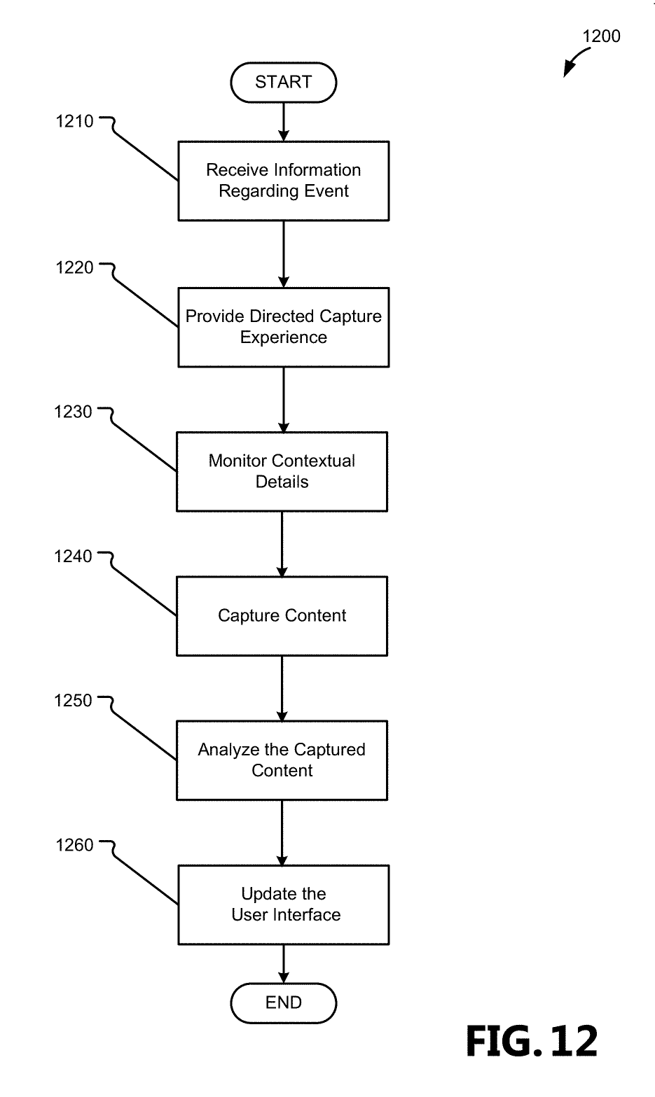

FIG. 12 is a flow chart showing general stages involved in an example method 1200 for providing directed content capture and content analysis.

Method 1200 begins at OPERATION 1210, where the directed content capture and content analysis system 130 receives information regarding an event. In one example, the directed content capture and content analysis system 130 receives an event type from the user utilizing the computing device 110. In another example, the directed content capture and content analysis system 130 analyzes a calendaring application associated with the computing device to identify and proactively offer assistance with providing a directed capture experience for the upcoming event.

At OPERATION 1220 the directed content capture and content analysis system 130 provides the directed capture experience to the user, including desirable content captures to document the event;

Method 1200 then proceeds to OPERATION 1230, where the directed content capture and content analysis system 130 monitors the contextual details associated with the computing device 110. In one example, the contextual details associated with the event include audio information, such as a song that indicates the start of desirable content. In another example, the contextual details associated with the computing device 110 include location information, which identifies a location associated with desirable content. Based on the monitored contextual details, the directed content capture and content analysis system 130 may provide a notification prompting the user to capture the desirable content. According to certain aspects, the notification may provide a minimally intrusive reminder for the user to document the event, without unduly impacting the user's experience.

At OPERATION 1240 the directed content capture and content analysis system 130 captures content.

At OPERATION 1250 the directed content capture and content analysis system 130 analyzes the captured content. In one example, the directed content capture and content analysis system 130 may analyze the captured content to verify that the captured content corresponds to an angle of view for desirable content. In another example, the directed content capture and content analysis system 130 may analyze the captured content to verify that all of the event attendees have been captured. In another example, the directed content capture and content analysis system 130 may analyze the captured content to verify that the captured content captures ideal shots of the content.

Method 1200 then proceeds to OPERATION 1260, where the directed content capture and content analysis system 130 updates the user interface to reflect captured content. When the captured content corresponds to one of the desirable content captures, the user interface may provide an indication that the content capture has been completed.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 13-15 and the associated descriptions provide a discussion of a variety of operating environments in which examples are practiced. However, the devices and systems illustrated and discussed with respect to FIGS. 13-15 are for purposes of example and illustration and are not limiting of a vast number of computing device configurations that are utilized for practicing aspects, described herein.

FIG. 13 is a block diagram illustrating physical components (i.e., hardware) of a computing device 1300 with which examples of the present disclosure may be practiced. In a basic configuration, the computing device 1300 includes at least one processing unit 1302 and a system memory 1304. According to an aspect, depending on the configuration and type of computing device, the system memory 1304 comprises, but is not limited to, volatile storage (e.g., random access memory), non-volatile storage (e.g., read-only memory), flash memory, or any combination of such memories. According to an aspect, the system memory 1304 includes an operating system 1305 and one or more program modules 1306 suitable for running software applications 1350. According to an aspect, the system memory 1304 includes a directed content capture and content analysis application 130. The operating system 1305, for example, is suitable for controlling the operation of the computing device 1300. Furthermore, aspects are practiced in conjunction with a graphics library, other operating systems, or any other application program, and are not limited to any particular application or system. This basic configuration is illustrated in FIG. 13 by those components within a dashed line 1308. According to an aspect, the computing device 1300 has additional features or functionality. For example, according to an aspect, the computing device 1300 includes additional data storage devices (removable and/or non-removable) such as, for example, magnetic disks, optical disks, or tape. Such additional storage is illustrated in FIG. 13 by a removable storage device 1309 and a non-removable storage device 1310.

As stated above, according to an aspect, a number of program modules and data files are stored in the system memory 1304. While executing on the processing unit 1302, the program modules 1306 (e.g., a directed content capture and content analysis application 130) perform processes including, but not limited to, one or more of the stages of the method 1200 illustrated in FIG. 12. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 13 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 1300 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 1300 has one or more input device(s) 1312 such as a keyboard, a mouse, a pen, a sound input device, a touch input device, etc. The output device(s) 1314 such as a display, speakers, a printer, etc. are also included according to an aspect. The aforementioned devices are examples and others may be used. According to an aspect, the computing device 1300 includes one or more communication connections 1316 allowing communications with other computing devices 1318. Examples of suitable communication connections 1316 include, but are not limited to, radio frequency (RF) transmitter, receiver, and/or transceiver circuitry; universal serial bus (USB), parallel, and/or serial ports.

The term computer readable media, as used herein, includes computer storage media. Computer storage media include volatile and nonvolatile, removable and non-removable media implemented in any method or technology for storage of information, such as computer readable instructions, data structures, or program modules. The system memory 1304, the removable storage device 1309, and the non-removable storage device 1310 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1300. According to an aspect, any such computer storage media is part of the computing device 1300. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

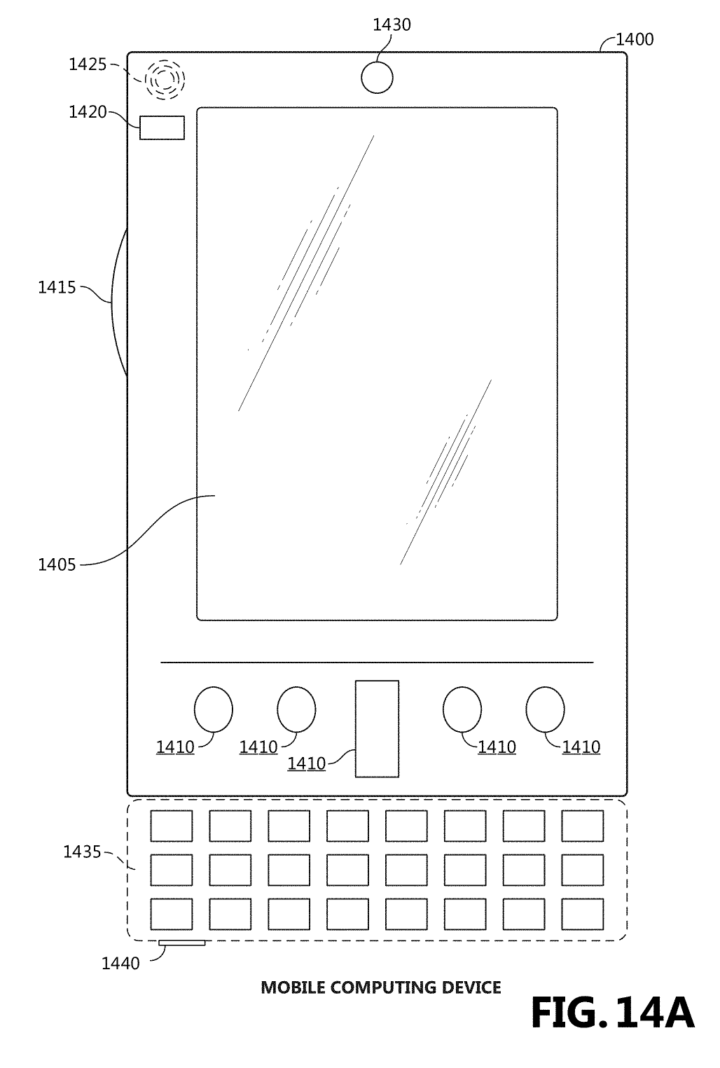

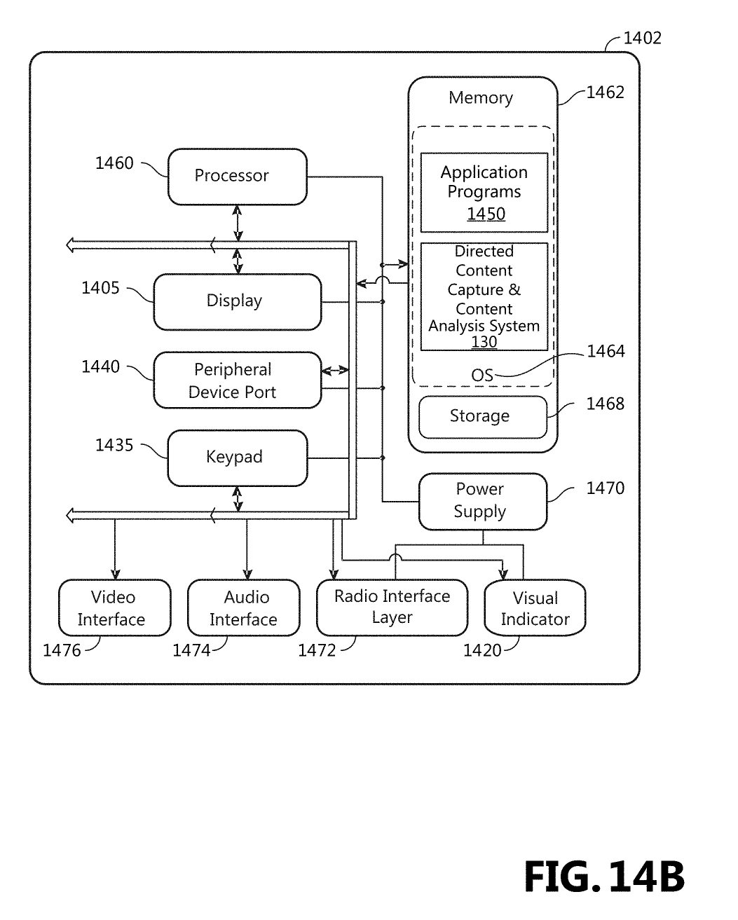

FIGS. 14A and 14B illustrate a mobile computing device 1400, for example, a mobile telephone, a smart phone, a tablet personal computer, a laptop computer, and the like, with which aspects may be practiced. With reference to FIG. 14A, an example of a mobile computing device 1400 for implementing the aspects is illustrated. In a basic configuration, the mobile computing device 1400 is a handheld computer having both input elements and output elements. The mobile computing device 1400 typically includes a display 1405 and one or more input buttons 1410 that allow the user to enter information into the mobile computing device 1400. According to an aspect, the display 1405 of the mobile computing device 1400 functions as an input device (e.g., a touch screen display). If included, an optional side input element 1415 allows further user input. According to an aspect, the side input element 1415 is a rotary switch, a button, or any other type of manual input element. In alternative examples, mobile computing device 1400 incorporates more or fewer input elements. For example, the display 1405 may not be a touch screen in some examples. In alternative examples, the mobile computing device 1400 is a portable phone system, such as a cellular phone. According to an aspect, the mobile computing device 1400 includes an optional keypad 1435. According to an aspect, the optional keypad 1435 is a physical keypad. According to another aspect, the optional keypad 1435 is a “soft” keypad generated on the touch screen display. In various aspects, the output elements include the display 1405 for showing a graphical user interface (GUI), a visual indicator 1420 (e.g., a light emitting diode), and/or an audio transducer 1425 (e.g., a speaker). In some examples, the mobile computing device 1400 incorporates a vibration transducer for providing the user with tactile feedback. In yet another example, the mobile computing device 1400 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 1400 incorporates peripheral device port 1440, such as an audio input (e.g., a microphone jack), an audio output (e.g., a headphone jack), and a video output (e.g., a HDMI port) for sending signals to or receiving signals from an external device.

FIG. 14B is a block diagram illustrating the architecture of one example of a mobile computing device. That is, the mobile computing device 1400 incorporates a system (i.e., an architecture) 1402 to implement some examples. In one example, the system 1402 is implemented as a “smart phone” capable of running one or more applications (e.g., browser, e-mail, calendaring, contact managers, messaging clients, games, and media clients/players). In some examples, the system 1402 is integrated as a computing device, such as an integrated personal digital assistant (PDA) and wireless phone.

According to an aspect, one or more application programs 1450 are loaded into the memory 1462 and run on or in association with the operating system 1464. Examples of the application programs include phone dialer programs, e-mail programs, personal information management (PIM) programs, word processing programs, spreadsheet programs, Internet browser programs, messaging programs, and so forth. According to an aspect, a directed content capture and content analysis application 130 is loaded into memory 1462. The system 1402 also includes a non-volatile storage area 1468 within the memory 1462. The non-volatile storage area 1468 is used to store persistent information that should not be lost if the system 1402 is powered down. The application programs 1450 may use and store information in the non-volatile storage area 1468, such as e-mail or other messages used by an e-mail application, and the like. A synchronization application (not shown) also resides on the system 1402 and is programmed to interact with a corresponding synchronization application resident on a host computer to keep the information stored in the non-volatile storage area 1468 synchronized with corresponding information stored at the host computer. As should be appreciated, other applications may be loaded into the memory 1462 and run on the mobile computing device 1400.

According to an aspect, the system 1402 has a power supply 1470, which is implemented as one or more batteries. According to an aspect, the power supply 1470 further includes an external power source, such as an AC adapter or a powered docking cradle that supplements or recharges the batteries.

According to an aspect, the system 1402 includes a radio 1472 that performs the function of transmitting and receiving radio frequency communications. The radio 1472 facilitates wireless connectivity between the system 1402 and the “outside world,” via a communications carrier or service provider. Transmissions to and from the radio 1472 are conducted under control of the operating system 1464. In other words, communications received by the radio 1472 may be disseminated to the application programs 1450 via the operating system 1464, and vice versa.

According to an aspect, the visual indicator 1420 is used to provide visual notifications and/or an audio interface 1474 is used for producing audible notifications via the audio transducer 1425. In the illustrated example, the visual indicator 1420 is a light emitting diode (LED) and the audio transducer 1425 is a speaker. These devices may be directly coupled to the power supply 1470 so that when activated, they remain on for a duration dictated by the notification mechanism even though the processor 1460 and other components might shut down for conserving battery power. The LED may be programmed to remain on indefinitely until the user takes action to indicate the powered-on status of the device. The audio interface 1474 is used to provide audible signals to and receive audible signals from the user. For example, in addition to being coupled to the audio transducer 1425, the audio interface 1474 may also be coupled to a microphone to receive audible input, such as to facilitate a telephone conversation. According to an aspect, the system 1402 further includes a video interface 1476 that enables an operation of an on-board camera 1430 to record still images, video stream, and the like.

According to an aspect, a mobile computing device 1400 implementing the system 1402 has additional features or functionality. For example, the mobile computing device 1400 includes additional data storage devices (removable and/or non-removable) such as, magnetic disks, optical disks, or tape. Such additional storage is illustrated in FIG. 14B by the non-volatile storage area 1468.

According to an aspect, data/information generated or captured by the mobile computing device 1400 and stored via the system 1402 are stored locally on the mobile computing device 1400, as described above. According to another aspect, the data are stored on any number of storage media that are accessible by the device via the radio 1472 or via a wired connection between the mobile computing device 1400 and a separate computing device associated with the mobile computing device 1400, for example, a server computer in a distributed computing network, such as the Internet. As should be appreciated such data/information are accessible via the mobile computing device 1400 via the radio 1472 or via a distributed computing network. Similarly, according to an aspect, such data/information are readily transferred between computing devices for storage and use according to well-known data/information transfer and storage means, including electronic mail and collaborative data/information sharing systems.

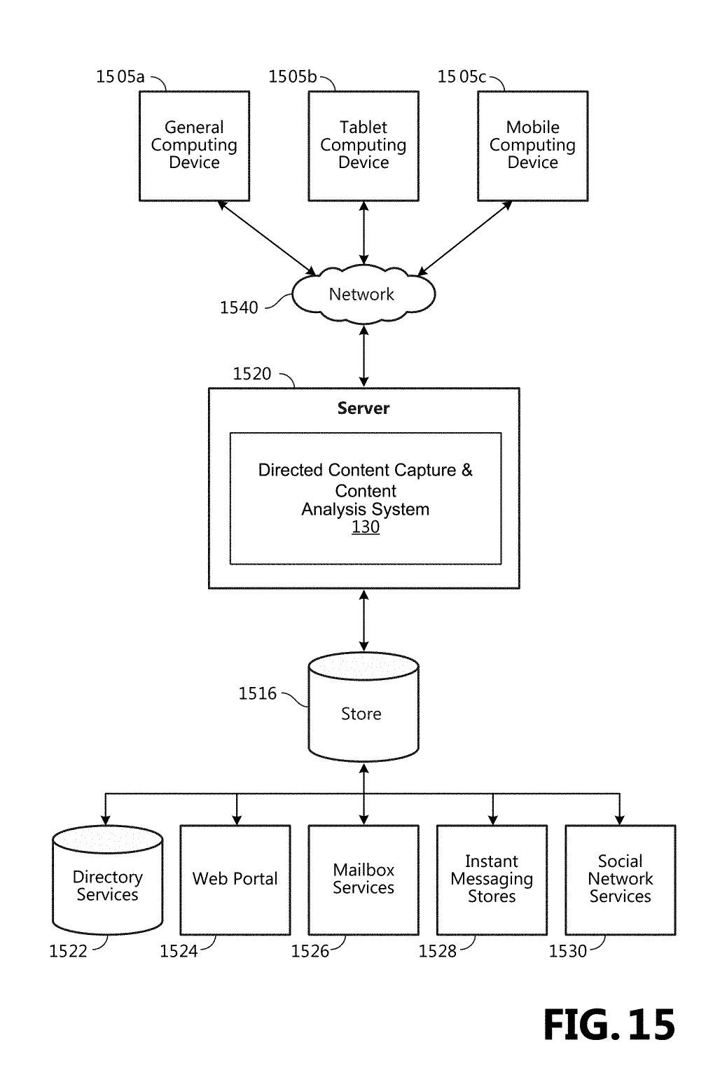

FIG. 15 illustrates one example of the architecture of a system for directed content capture and content analysis as described above. Content developed, interacted with, or edited in association with the directed content capture and content analysis application 130 is enabled to be stored in different communication channels or other storage types. For example, various documents may be stored using a directory service 1522, a web portal 1524, a mailbox service 1526, an instant messaging store 1528, or a social networking site 1530. The directed content capture and content analysis application 130 is operative to use any of these types of systems or the like for directed content capture and content analysis, as described herein. According to an aspect, a server 1520 provides the directed content capture and content analysis application 130 to clients 1505a,b,c. As one example, the server 1520 is a web server providing the directed content capture and content analysis application 130 over the web. The server 1520 provides the directed content capture and content analysis application 130 over the web to clients 1505 through a network 1540. By way of example, the client computing device is implemented and embodied in a personal computer 1505a, a tablet computing device 1505b or a mobile computing device 1505c (e.g., a smart phone), or other computing device. Any of these examples of the client computing device are operable to obtain content from the store 1516.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A method for providing directed content capture and content analysis, comprising:
receiving a selection to provide a directed capture experience on a computing device;
receiving information regarding an event;
displaying a user interface providing the directed capture experience including desirable content captures to document the event;
receiving a selection to capture content;
capturing the content;
analyzing the captured content;
identifying whether the captured content corresponds to one of the desirable content captures; and
updating the user interface to reflect whether the captured content corresponds to one of the desirable content captures.

2. The method of claim 1, wherein analyzing the captured content further comprises verifying that the captured content corresponds to an angle of view for desirable content.

3. The method of claim 1, wherein analyzing the captured content further comprises verifying that event attendees are captured.

4. The method of claim 1, further comprising monitoring contextual details associated with the event.

5. The method of claim 4, wherein the contextual details associated with the event include aural information.

6. The method of claim 5, aural information includes a song that indicates the start of desirable content.

7. The method of claim 6, further comprising providing a notification prompting the user to capture the desirable content.

8. The method of claim 4, wherein the contextual details associated with the computing device includes location information.

9. The method of claim 8, further comprising providing a notification that the computing device is at a location associated with desirable content.

10. The method of claim 1, wherein updating the user interface to reflect whether the captured content corresponds to one of the desirable content captures further comprises displaying whether the capture of the desirable content is completed.

11. A system for providing directed content capture and content analysis, comprising:
a processing unit; and
a memory including computer readable instructions, which when executed by the processing unit, causes the system to be operable to:
receive a selection to provide a directed capture experience on a computing device;
receive information regarding an event;
display a user interface providing the directed capture experience including desirable content captures to document the event;
receive a selection to capture content;
capture the content;
analyze the captured content;
identify whether the captured content corresponds to one of the desirable content captures; and
update the user interface to reflect whether the captured content corresponds to one of the desirable content captures.

12. The system of claim 11, wherein analyzing the captured content further comprises verifying that the captured content corresponds to an angle of view for desirable content.

13. The system of claim 11, further comprising monitoring contextual details associated with the event.

14. The system of claim 13, wherein the contextual details associated with the event include aural information.

15. The system of claim 14, aural information includes a song that indicates the start of desirable content.

16. The system of claim 15, further comprising providing a notification prompting the user to capture the desirable content.

17. The system of claim 13, wherein the contextual details associated with the computing device include location information.

18. The system of claim 17, further comprising providing a notification that the computing device is at a location associated with desirable content.

19. The system of claim 11, wherein updating the user interface to reflect whether the captured content corresponds to one of the desirable content captures further comprises displaying whether the capture of the desirable content is completed.

20. A computer readable storage media including computer readable instructions, which when executed by a processing unit, performs steps for providing directed content capture and content analysis, comprising:
receiving information regarding an event;
displaying a user interface providing the directed capture experience including desirable content captures to document the event;
monitoring contextual details associated with the computing device, wherein the contextual details associated with the computing device include aural information or location information;
providing a notification that the contextual details associated with the computing device that identifies an opportunity to capture desirable content;
receiving a selection to capture content;
capturing the content;
analyzing the captured content;
identifying whether the captured content corresponds to one of the desirable content captures; and
updating the user interface to reflect whether the captured content corresponds to one of the desirable content captures.
